(19) United States
(12) Patent Application Publication
(10) Pub. No.: US 2008/0113093 A1
(43) Pub. Date: May 15, 2008

(54) Moulded Plastic Components with Anti-Reflective and Anti-Glare Properties and Method for Their Manufacture

(76) Inventor: Michael John Hanney, Berkshire (GB)

Correspondence Address: FISH & RICHARDSON PC, P.O. BOX 1022, MINNEAPOLIS, MN, 55440-1022, US

(21) Appl. No.: 11/573,849

(22) PCT Filed: Aug. 12, 2005
(86) PCT No.: PCT/EP05/53976

§ 371 Date: Sep. 12, 2007

(30) Foreign Application Priority Data
Aug. 17, 2004 (GB) 0418335.6

(51) Int. Cl. B05D 5/06; B32B 9/00

(52) U.S. Cl. 427/162; 428/446

(57) ABSTRACT

The present invention relates to improvements in or relating to moulded plastics components. In particular, it relates to components with anti-reflective and anti-glare properties and methods for making the same. We describe a method for manufacturing a moulded plastic component comprising: applying an anti-reflective coating (12) to a first plastic film (11, 11a) having an anti-glare surface texture; inserting the first plastic film into a mould (2); and injecting plastic into the mould to form a component with anti-reflective properties and an anti-glare surface texture.

The present invention relates to improvements in or relating to moulded plastics components. In particular, it relates to components with anti-reflective and anti-glare properties and methods for making the same.

Many moulded plastic components require specialist optical properties to improve their visual appearance. For example, a vehicle instrument cover (i.e. the transparent facia over the instruments) must allow a driver to clearly view instruments behind it without interference from reflections or glare generated by light falling on the cover.

These optical properties have traditionally been incorporated after the component has been moulded. For example, an anti-reflective coating can be applied to the component surface after moulding by dipping it into an anti-reflective resin. However, flow lines as the coating runs on the surface; the build up of resin around ribs, holes, bosses etc.; membranes forming over holes; and the puddling of the coating in recessed areas of the component make it difficult to produce an even coating on a complex moulding. An anti-glare textured finish may also be applied after moulding but it is difficult to apply an even texture to a contoured moulding. Consequently, the optical properties of components such as vehicle instrument covers have not been effective for sufficiently reducing glare and vehicle dashboards include a brow or recess to shade the covers and prevent reflection and glare.

Accordingly, there is need for an efficient means for manufacturing complex, contoured plastic components that have the required optical properties. Preferably, the components should be made using a single moulding step with no need for further processing after the moulding is completed.

The present invention seeks to address these problems by applying optical coatings to a thin film, which is fixed to the component during the moulding process. Injection moulded plastic products are often decorated using a technique known as “In-Mould Labelling” (IML), “Film Insert Moulding” (FIM) or “In Mould Decoration” (IMD). A thin film of plastic is pre-printed with appropriate graphics using conventional printing techniques, and cut to the required shape to form a label. The label is placed in an injection moulding tool, preferably against one side of the mould cavity and then the plastic for forming the product is injected into the cavity. When the plastic sets, the label is permanently attached to the moulded product and a fully decorated product is produced directly from the moulding process. This process is used, for example, to manufacture facia components for mobile telephones.

The inventor has been the first to realise that this technique can be used to apply film with optical coatings to a component during the moulding process.

According to one aspect of the present invention, there is provided a method for manufacturing a moulded plastic component comprising: applying an anti-reflective coating to a first plastic film; inserting at least a piece of the film into a mould; and injecting plastic into the mould to form a component with anti-reflective properties.

Preferably, the anti-reflective coating is applied to the first film by a multilayer vacuum deposition process. Preferably, the anti-reflective coating comprises alternating layers of a low refractive index material and a high refractive index material; alternating layers of SiO₂ and TiO₂; or a resin based anti-reflective coating. Preferably, the substrate of the first film comprises polycarbonate; or a Light Control Film. Preferably, the first film has any one of more of the following additional properties: an anti-glare surface texture; a hard-coat between the film substrate and the anti-reflective coating; a colour tint; and a printed pattern on one surface.

In one embodiment, the method further comprises: inserting a second plastic film into the mould; injecting the plastic into the mould such that the first film adheres to one face of the component and the second film adheres to an opposite face of the component. Preferably, the second film has any one of the following properties: an anti-glare surface texture; a hard-coat between the film substrate and the anti-reflective coating; a colour tint; a printed pattern on one surface; and a moth-eye pattern on one surface.

In an alternative embodiment, the component has a moth-eye structure moulded into the face opposite the face to which the first film adheres.

According to a second aspect of the invention, there is provided a moulded plastic component comprising: a plastic substrate; and a plastic film, attached to a surface of the substrate, wherein the film is coated with an anti-reflective coating.

According to a third aspect of the invention, there is provided a plastic film comprising a substrate with a textured anti-glare surface finish, coated with an anti-reflective coating.

The above and other aspects of the present invention will now be described, by way of example, with reference to the accompanying drawings, in which:

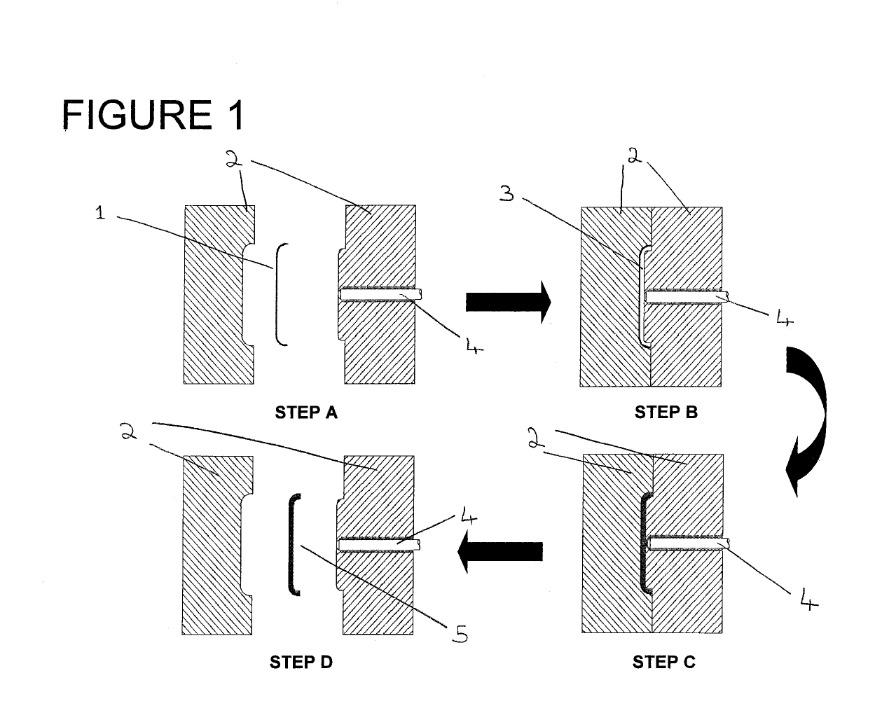

FIG. 1 shows schematically the steps of an In-Mould-Label (IML) Process;

FIG. 2 is a schematic cross-section of a plastic film with an anti-reflective coating;

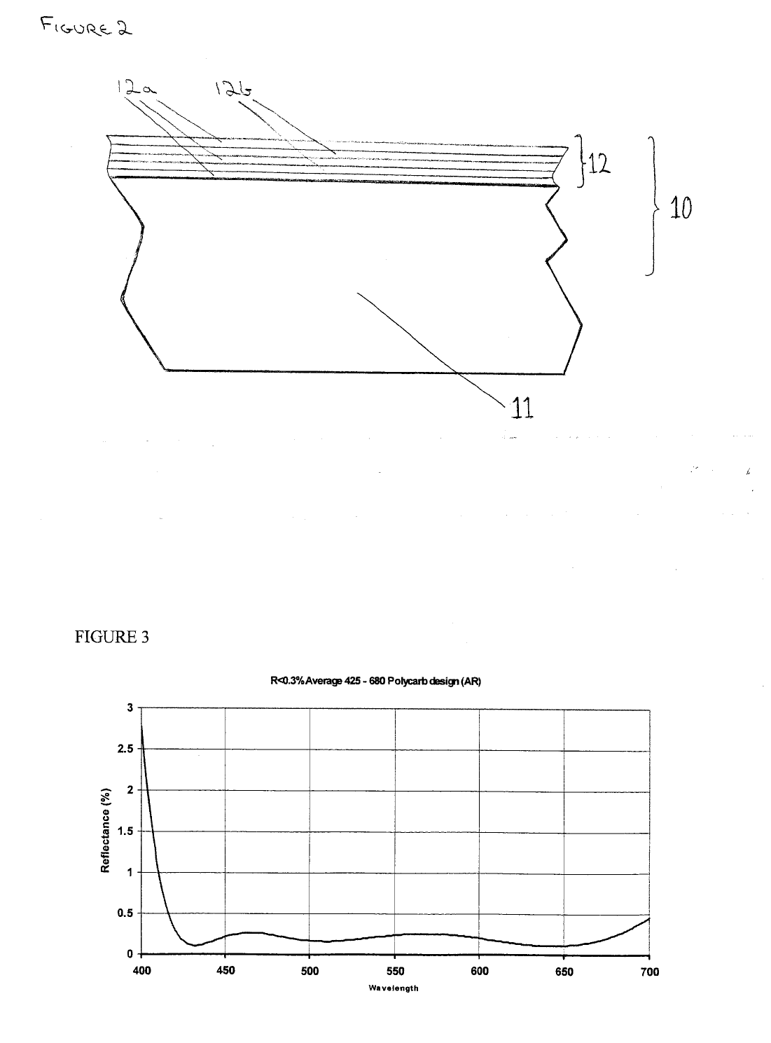

FIG. 3 is a graph showing measured reflectance from the film of FIG. 2;

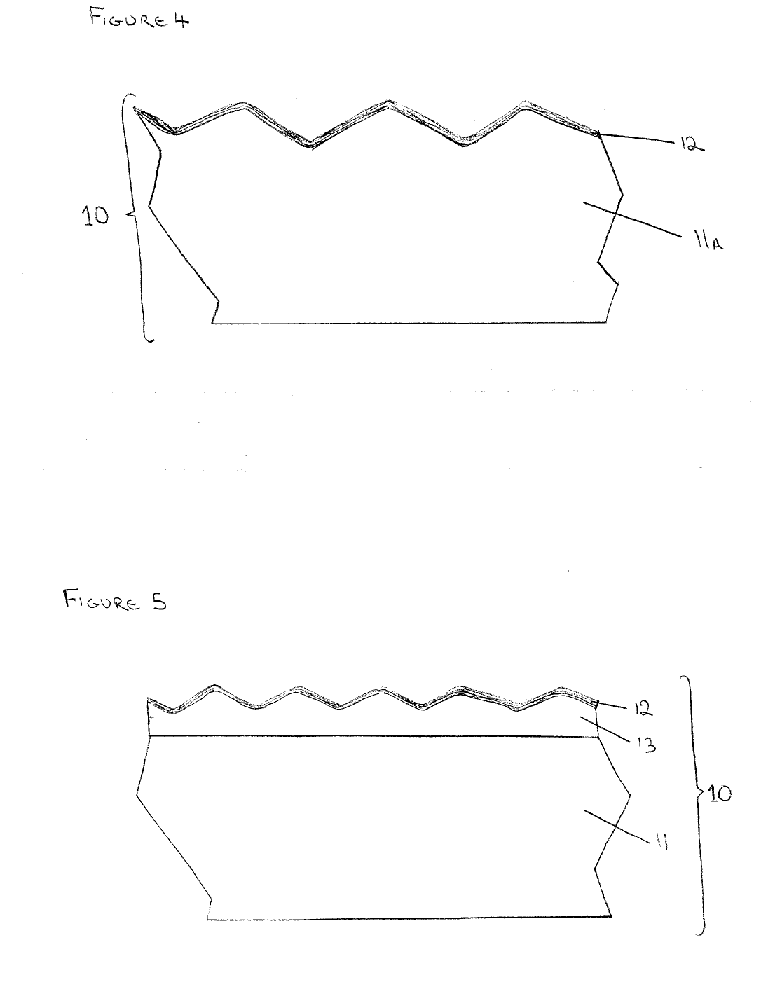

FIG. 4 is a schematic a cross-section of an anti-glare film with an anti-reflective coating;

FIG. 5 is a schematic cross-section of a film with a hard-coat having an anti-glare surface and an anti-reflective coating;

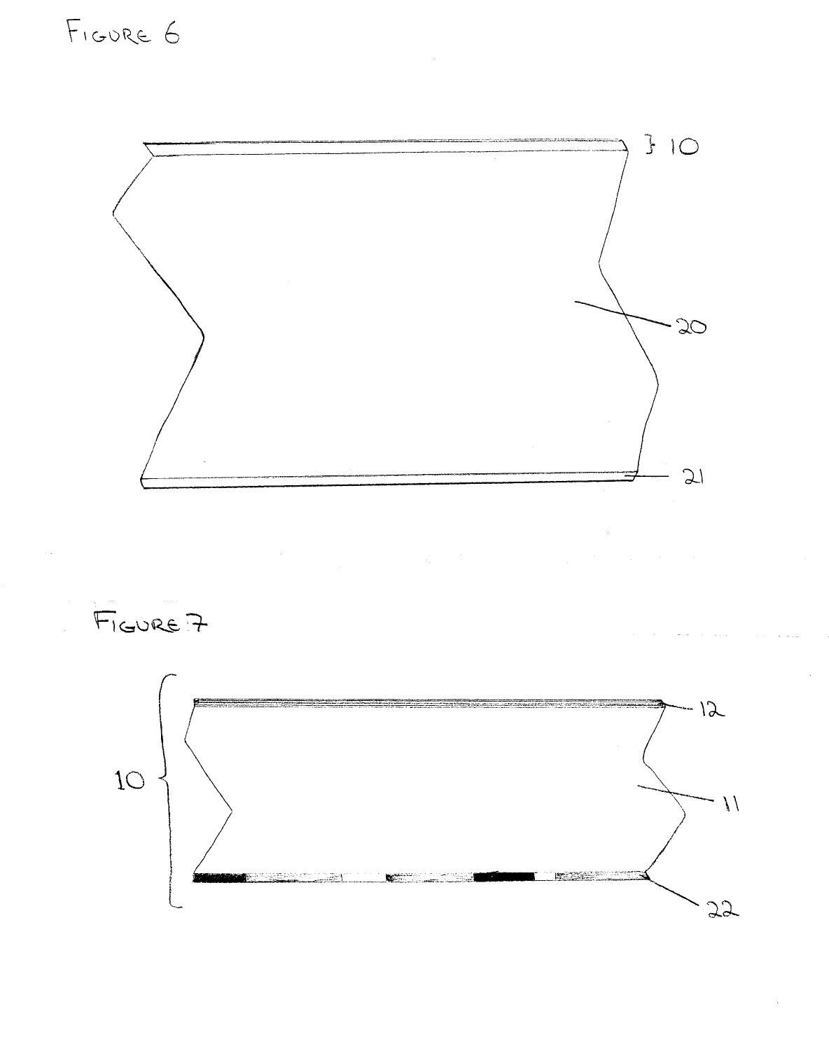

FIG. 6 is a schematic cross-section of an embodiment of a plastic component in accordance with the second aspect of the present invention incorporating the film label from FIG. 2 on a first face and a film label with moth-eye anti-reflective properties a second face, and

FIG. 7 is a schematic cross section of an embodiment of an anti-reflective film according to the third aspect of the present invention with additional back printed decorative artwork.

An IML manufacturing process will now be described with reference to FIG. 1. In step A, a label 1 formed from a piece of film is placed on an internal surface of a cavity in one half of a moulding tool 2. This may be done manually but in an automated production line it can be done more quickly and accurately by machine. The label 1 may be flat or it may be pre-formed into approximately the shape of the component to be labelled. Pre-forming enables components with more extreme shapes (i.e. sharper angles or tighter curves) to be labelled without the label film wrinkling or distorting excessively.

In step B, the two halves of the tool 2 are brought together to form a cavity 3 defining the desired shape of the moulded component. The label 1 is held in place against the side of the mould cavity 3 by its pre-formed shape, by tabs, by a vacuum or by clamps, depending on the design of the particular component.

In step C, a hot plastic “melt” is injected through the injection bore 4 to fill the cavity 3 with plastic, which warms the label 1 and presses it against the contours of the cavity so that it distorts to the shape of the cavity 3. The component is allowed to cool so that the plastic melt sets with the film attached to its surface.

At step D, the two halves of the moulding tool 2 are separated and the finished moulded and patterned component 5 is ejected. If necessary, tabs from the label 1 are cut off to the edge of the moulded component 5.

In an IML process, the material of the film used to make the label must be compatible with the hot plastic melt so that the label and the plastic adhere to each other. Typically, this means that they are the same material, for example a polycarbonate film and a polycarbonate melt. If the label film is not directly compatible with the melt, a “tie coat” can be applied to the back face of the film as a primer in order to ensure strong adhesion to the component. The tie coat is applied to the back face of the label film using a known technique.

In accordance with one aspect of the present invention, an optical coating is applied to the film prior to the IML process and prior to any necessary pre-forming of the label 1. It is easier to apply even coatings to the flat surface of the film than to the contoured surface of a moulded component. As a result, it is possible to control the optical characteristics far more precisely than previously possible.

FIG. 2 shows an optical film 10 in accordance with another aspect of the present invention. In accordance with another aspect of the present invention, a label may be cut from such a film 10 for use in the IML process described above, preferably using an appropriately shaped stamp.

The film 10 comprises a plastic membrane 11 with an anti-reflective coating 12. In a preferred embodiment, the membrane 11 is made from polycarbonate with a thickness in the range from 100 μm to 250 μm, and preferably 175 μm. The membrane 11 cannot be too thin, otherwise it will not be strong enough to be used in the IML process and will tear. It cannot be too thick, otherwise it will not be heated sufficiently during the IML process and will not distort to properly conform to the contours of the moulded component, resulting in stresses within the component or possibly de-lamination of the film from the component after the IML process. One surface of the membrane 11 is coated with an anti-reflective coating 12.

This coating 12 may comprise a conventional resin based anti-reflective coating applied by dipping the membrane into liquid resin. However, the anti-reflective coating 12 preferably comprises alternate layers of a low refractive index material, such as silicon dioxide 12a, and a high refractive index material, such as titanium dioxide 12b. The thickness of the layers is calculated to produce optical interference of light reflected from each interface, such that most of the reflected light is effectively cancelled. The appropriate thickness of each layer is therefore dependent upon the refractive indicies of the materials forming the film 10 (i.e. membrane 11 and coating 12) and the expected wavelength of incident light. In a preferred embodiment, the coating 12 comprises five layers, three being silicon dioxide and two being titanium dioxide. In a preferred embodiment, the silicon dioxide layer nearest the polycarbonate is 21.8 nm thick, the next titanium dioxide layer is 16.7 nm thick, the next silicon dioxide layer is 34.0 nm thick, the next titanium dioxide layer is 124.9 nm thick and the final silicon dioxide layer is 90.4 nm thick. However, the number of layers and the thickness of each layer clearly depend upon the specification of the film 10, with more layers allowing more wavelengths of incident light to be precisely targeted.

The layering enables very fine control over the optical properties of the film 10 and allows the anti-reflective properties to be fine tuned for a variety of applications. However, it is important to deposit the layers 12a, 12b very evenly and accurately over the surface of the membrane 11. Accordingly, in a preferred embodiment, the layers 12a, 12b are applied by vacuum deposition using a microwave assisted sputtering process. This process involves the deposition of inorganic materials on the membrane 11 in a vacuum.

In a preferred embodiment, plasma assisted electron deposition is used. The plasma assist provides a means for pre-conditioning the membrane or sub-layer surface prior to dielectric deposition as a means of enhancing adhesion and minimizing intrinsic stress. Such a deposition process is described in EP 1 154 459 A. This process allows precise control deposition of very thin layers of material the anti-reflective material, such that even layers can be deposited over the membrane 11 with a very high degree of accuracy. Importantly, the membrane 11 is protected from thermal-damage by this low temperature process. Deposition processes that require significant substrate heating would disadvantageously melt the polycarbonate membrane 11.

In an exemplary deposition, the vacuum chamber was evacuated to 1×10⁻⁵ mBar prior to starting the process. The deposition source is an electron-beam crucible evaporator and the amount of oxygen introduced via the plasma source is used to precisely control the refractive index of each layer 12a, 12b.

The anti-reflective properties of the exemplary film 10 described above were tested at different wavelengths. A graph of the percentage of incident light reflected for various wavelengths of incident light is shown in FIG. 3. On average, such films were found to have a normal incident surface reflection of less than 0.3%.—that is less than 0.3% of the light hitting the surface was reflected and more than 99.7% of the incident light was transmitted.

Anti-glare films can be created using a very finely roughened surface. Such surfaces scatter reflected light, so the perceived reflection at a point (e.g. a viewer's eye) is reduced. However, because the incident light is also scattered, there is also a corresponding reduction in light transmitted through the surface. A smooth surface will cleanly reflect most incident light and appear to be shiny. Thus, if the viewer's eye is appropriately positioned relative to a strong source of light, the viewer will see the reflection of that source as glare on the shiny surface. However, if the surface is finely textured, the incident light is scattered thereby reducing the intensity of the reflection that reaches the user's eye. The surface appears dull and a reflection of the strong source of light will be more diffuse. Such a surface is said to have an anti-glare finish.

The amount of roughening of the surface is important and dependent on the application. The more textured the anti-glare surface, the more difficult it is to see through it. Also, although light that would be reflected by a smooth surface to a viewer's eye is diffused by greater texturing, extraneous rays, that would not normally be reflected towards a viewer's eye may be directed to the viewer's eye by the texturing, having the opposite effect to that desired. Typically, an anti-glare texture might be used to reduce the reflective properties of a transparent surface to 75% of that of a full gloss surface.

Traditionally, coatings have not been applied to anti-glare surfaces, since the coatings tend to smooth over the roughened surface. As a result, an anti-glare surface dipped into an anti-reflective coating does not provide a significant improvement over an anti-reflective coating on a smooth surface. In addition, the roughened surface affects the flow of the anti-reflective material over the film surface causing additional manufacturing problems, particularly flow lines in the coating.

However, the vacuum deposition process described above is sufficiently versatile to allow the application of an anti-reflective coating 12 to a film 10 with an anti-glare finish. FIG. 4 shows a cross section of such a film, comprising a polycarbonate membrane 11A with an anti-glare texture on its upper surface; and an anti-reflective coating 12. The coating layers closely follows the contours of the anti-glare texture, so that the final film 10 has a textured surface and exhibits both anti-reflective and anti-glare properties. This ability of the coating layers to follow the contours of the anti-glare texture results from the very thin layer of anti-reflective coating 12 that can be applied using the vacuum deposition process.

For some applications, it is desirable to add a hard-coat 13 to the membrane 11 prior to applying the anti-reflective coating 12. This gives the soft membrane 11a harder, more durable surface on which the anti-reflective coating 12 can be applied. FIG. 5 shows a cross section of such a film, comprising a polycarbonate film 11; a hard-coat 13 with an anti-glare textured surface; and an anti-reflective coating 12.

The hard-coat 13 may comprise a poly-siloxane based resin. Monomeric materials, such as acrylates, can be added to modify its chemical resistance and hardness properties as required. The hard-coat 13 may be thermally cured but is preferably cured using ultra-violet light because of the increased speed of this process and the reduced thermal impact on the polycarbonate membrane 11.

The hard-coat 13 is typically between 1 μm and 10 μm thick but is preferably approximately 5 μm thick. This gives the best balance between coating durability and flexibility.

The anti-glare texture can be formed in the membrane 11 and then over-coated with the hard coat resin. Although the hard-coat layer will smooth the anti-glare texture, this can be compensated by initially applying a coarser anti-glare finish to the membrane 11 before the hard-coat 13 is applied.

However, the anti-glare texture is preferably formed in the hard-coat 13 itself. In one embodiment, the desired anti-glare surface texture is created by adding a filler, such as tiny glass beads, to the hard-coat 13 to give the desired rough surface. In an alternative embodiment, the drying rate and flow characteristics of the hard-coat 13 can be modified so that a fine spray finish texture is retained in the coating to give the desired anti-glare surface texture. In yet another alternative embodiment, an anti-glare surface texture is embossed into a semi-dried hard-coat 13 prior to final curing.

Optical coatings such as those described above are generally used on the front surface of a component, since this interface generates the majority of reflection and glare from the component. However, the optical properties of the back surface of a transparent or translucent component can also be significant in certain applications, since incident light rays are reflected by this interface as well as the front surface.

It is possible to use an anti-reflective film of the type described above on the back surface of a component in order to prevent reflection from this interface. In this case, the coating layers 12 are adapted to suit the particular requirements.

Another way to reduce reflection from the back surface of a component is to use a “moth-eye” pattern, so called because it was first observed on the eyes of moths. The moth-eye pattern can be imprinted, moulded or etched into a surface (not coated onto a surface) to reduce reflection and glare. Film imprinted with a moth-eye pattern can be commercially obtained and this can be used in an IML process as described above.

Such films can be effectively used in conjunction with the present invention in a component such as that shown in cross section in FIG. 6. Such a component comprises a transparent plastic substrate 20 with the film 10 of FIG. 5 on the top surface (which will form the front surface of the component when in use). On the bottom surface is a moth eye film 21, which reduces reflection and glare from the bottom surface. Such a component is ideal for use, for example, in display screens or instrument covers.

It is also possible to mould the moth-eye pattern directly onto the back of the component during the manufacturing process. Direct moulding results in a moth-eye pattern of similar quality to commercially available moth-eye films but results in a simpler, cheaper manufacturing process because the cost of manufacturing and handling the second label is avoided.

Traditionally, graphic images have been applied to IML films. Such graphics 22 can be applied to the back of anti-reflective, anti-glare films to further enhance the component. Such graphics 22 are applied to the back surface of the film 10 using traditional screen printing techniques, before or after the anti-reflective coating 12 or the anti-glare texture has been applied. A cross section of such a film is shown in FIG. 7.

Light Control Films (LCF) are commercially available (e.g. from 3M company) which consist of a very fine louvre pattern within the thickness of the film. These louvres allow light to pass through the film when incident at a desired angle but to be absorbed by the louvres in the film when incident at angles away from the desired angle. Such films are commonly used as “privacy screens” for computer monitors. An anti-glare surface can be applied to such films to enhance optical characteristics. The vacuum deposition process described above can be applied to such film to provide anti-reflective properties. The application of any of the adaptations or processes described herein to an LCF therefore provides the opportunity to produce IML films with a variety of optical properties.

In some applications, it is desirable to use a tint in the plastic substrate of the component. This may be applied by adding a dye to the plastic melt prior to injection into the mould. The tint will have light filtering and absorbency properties, which will reduce the amount of incident light reaching the back surface of the component and reduce the amount of light reflected from the back surface reaching a viewer's eye. This can be used in place of or in combination with a coated film or moth-eye moulding to reduce the reflections from the back surface of the component.

The tint can also be used to enhance certain optical properties of the component. For example, a display device with predominantly red graphics could be equipped with a lens or cover component with a red transmission filter so that only red wavelengths are transmitted through the component. In this way, the component absorbs a large proportion of the unwanted light that would otherwise enter the display unit but the display is transmitted through the component to the viewer with high contrast.

Tint may also be applied to the IML film material. This allows more accurate control of the filtering activities of the component.

One example of the use of the films described above to manufacture components is in the manufacture of a transparent cover for a brow-less instrument cluster for automotive applications. This application requires good anti-reflective and anti-glare properties but it is important that the instruments can be clearly seen through the cover.

All of the above features can be used in various combinations in such a cover, although a number of factors need to be considered when designing the component.

The density of the anti-glare texture and its separation from the instrument displays has a significant effect on the clarity with which the instruments can be seen. In particular, the closer the instrument displays are to the cover, the less the display is blurred by the anti-glare texture. It is therefore desirable to have the instruments as close as possible to the cover.

The colour chosen for the instrument display can also have a significant effect on the component design. The use of a white display limits the effects of tint in the cover, since white light is a combination of all colours and so no rays can be filtered out. It is therefore considered most appropriate to use a display emitting or reflecting a narrow range of wavelengths of light.

Various combinations of films, coatings, textures and colours have been described in the foregoing description. However, it will be obvious to one skilled in the art that various other combinations are possible and, accordingly, the scope of the present invention is not limited to the examples described but by the scope of the following claims.

1. A method for manufacturing a moulded plastic component comprising: applying an anti-reflective coating to a first plastic film having an anti-glare surface texture; inserting the first plastic film into a mould; and injecting plastic into the mould to form a component with anti-reflective properties and an anti-glare surface texture.

2. A method according to claim 1, wherein the anti-reflective coating is applied to the first film by a multilayer vacuum deposition process.

3. A method according to claim 1, wherein the anti-reflective coating comprises: alternating layers of a low refractive index material and a high refractive index material; alternating layers of SiO₂ and TiO₂; or a resin based anti-reflective coating.

4. A method as claimed in claim 1 wherein the first film comprises a film substrate.

5. A method as claimed in claim 4 wherein the film substrate is selected from polycarbonate substrates and light control films, having very fine louvre patterns within the thickness of the film.

6. A method as claimed in claim 4 wherein the first plastic film further comprises a hard-coating between the film substrate and the anti-reflective coating.

7. A method as claimed in claim 1 wherein the first plastic film has a colour tint.

8. A method as claimed in claim 1 wherein the first plastic film has a printed pattern on a surface thereof.

9. A method according to claim 1, further comprising: inserting a second plastic film into the mould; injecting the plastic into the mould such that the first film adheres to one face of the component and the second film adheres to an opposite face of the component.

10. A method as claimed in claim 9 wherein the second plastic film comprises a second film substrate and comprises a hard-coat between the film substrate and the anti-reflective coating.

11. A method according to claim 9, wherein the second film has one or more additional properties selected from an anti-glare surface texture; a colour tint; a printed pattern on a surface thereof; and a moth-eye pattern on a surface thereof.

12. A method as claimed in claim 1, wherein the component has a moth-eye structure moulded into the face opposite the face to which the first film adheres.

13. A moulded plastic component with an anti-glare surface texture, the component comprising:
a plastic substrate; and
a plastic film, attached to a surface of the substrate, wherein
the film has an anti-glare surface texture and is coated with an anti-reflective coating.

14. A plastic film with an anti-glare surface texture, the film comprising a substrate having an anti-glare surface texture, wherein said film further comprises an anti-reflective coating.

15. A method according to claim 2, wherein the anti-reflective coating comprises: alternating layers of a low refractive index material and a high refractive index material; alternating layers of SiO₂ and TiO₂; or a resin based anti-reflective coating.

16. A method as claimed in claim 2 wherein the first film comprises a film substrate.

17. A method as claimed in claim 3 wherein the first film comprises a film substrate.

18. A method as claimed in claim 16 wherein the film substrate is selected from polycarbonate substrates and light control films, having very fine louvre patterns within the thickness of the film.

19. A method a claimed in claim 17 wherein the film substrate is selected from polycarbonate substrates and light control films, having very fine louvre patterns within the thickness of the film.

20. A method according to claim 10, wherein the second film has one or more additional properties selected from an anti-glare surface texture; a colour tint; a printed pattern on a surface thereof; and a moth-eye pattern on a surface thereof.
